(19) United States
(12) Patent Application Publication
(10) Pub. No.: US 2020/0262226 A1
(43) Pub. Date: Aug. 20, 2020

(54) DEFROST/HEATING SOLUTION FOR GLAZED POLYCARBONATE

(71) Applicant: Magna Exteriors Inc., Concord (CA)

(72) Inventor: Pinelopi Thanou, Petoskey, MI (US)

(73) Assignee: Magna Exteriors Inc., Concord (CA)

(21) Appl. No.: 16/785,923

(22) Filed: Feb. 10, 2020

Related U.S. Application Data
(60) Provisional application No. 62/806,375, filed on Feb. 15, 2019.

(51) Int. Cl. B41M 1/30; B29C 45/14; H05B 3/84; C09D 11/52; C09D 183/04

(52) U.S. Cl. CPC B41M 1/30; B29C 45/14008; B29K 2069/00; C09D 11/52; C09D 183/04; H05B 3/84

(57) ABSTRACT

A plastic polycarbonate film is silk screen printed or printed with a robotic application or any other printing application, with a defrost grid composed from a flexible circuit of a silver or other thermoformable conductive inks and then trimmed/die cut to size. Once the plastic decoration is trimmed to size it is placed into an injection mold. In the molding process, the decorated insert is placed into the cavity or onto the core of an injection mold that has been designed for in-mold decorating. The desired molding resin is shot behind or over the insert, bonding its surface to the decorated insert and forming an integral finished part.

### CROSS-REFERENCE TO RELATED APPLICATIONS

This application claims priority to U.S. Provisional Patent Application No. 62/806,375 filed Feb. 15, 2019. The disclosure of the above application is incorporated herein by reference.

### FIELD OF THE INVENTION

The present invention relates to a defrost/heating solution for glazed polycarbonate.

### BACKGROUND OF THE INVENTION

There is a drive in the automotive field to reduce weight in the cars in order to achieve savings in fuel, or better mileage when it comes to EV vehicles, provide better aerodynamics and improved climate control. One way to contribute to the weight reduction is with replacing glass with polycarbonate. Backlight windows and radar covers are good candidates of parts that can be replaced with glazed polycarbonate.

### SUMMARY OF THE INVENTION

A plastic polycarbonate film is silk screen printed or printed with a robotic application or any other printing application, with a defrost grid composed from a flexible circuit of a silver or other thermoformable conductive inks and then trimmed/die cut to size creating a decorated insert. Once the decorated insert is trimmed to size it is placed into an injection mold.

In the molding process, the decorated insert is placed into the cavity or onto the core of an injection mold that has been designed for in-mold decorating. The desired molding resin is shot behind or over the insert, bonding its surface to the decorated insert and forming an integral finished part.

The advantage of this solution as described lays on the fact that the defrost grid can be at the outside surface of the window while is still completely protected with hard coat material over the polycarbonate or other equivalent hard coat technology, that will provide high level abrasion resistance and long term weathering so that the desired heat transfer rate to meet OEM requirements can be achievable.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of the method of creating a defrost on a polymer substrate according to one embodiment of the present invention.

FIG. 2 is a finished polycarbonate panel with a defrost according to one embodiment of the present invention.

FIG. 3 is a partial cross-sectional view of a portion of the defrost and the polycarbonate panel according to the present invention.

FIG. 4 is a cross-sectional view of a portion of a screen printed defrost according to the present invention.

### DETAILED DESCRIPTION OF THE PREFERRED EMBODIMENTS

The following description of the preferred embodiment(s) is merely exemplary in nature and is in no way intended to limit the invention, its application, or uses.

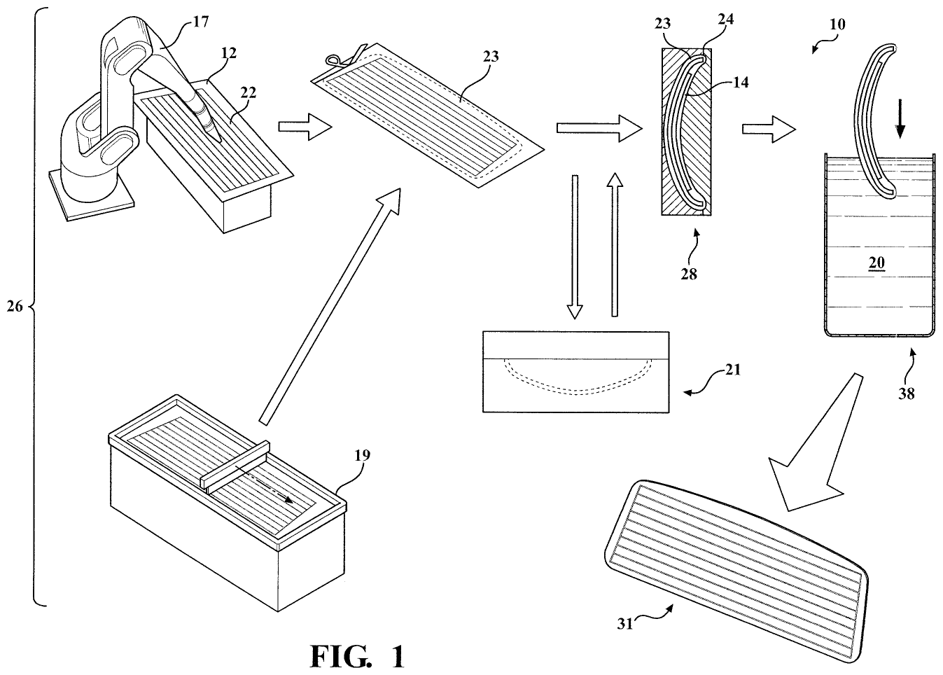

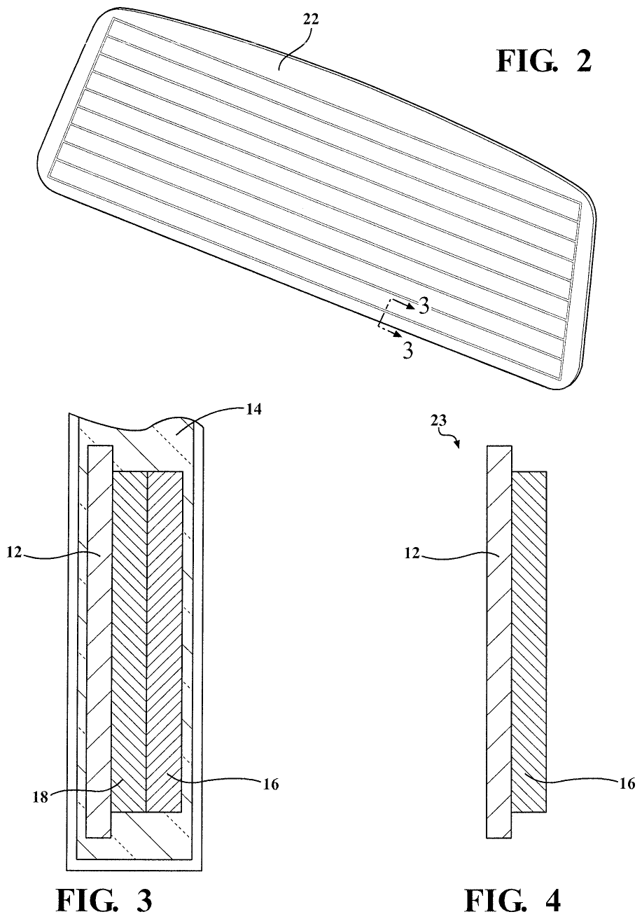

Referring now to FIG. 1 a schematic view of a method 10 of forming a defrost on a polymer substrate, such as polycarbonate is shown. Also The steps include providing several types of materials to form a layered structure. Referring also to FIGS. 3 and 4, the materials include a polymer film 12, typically formed of a thin layer of polycarbonate. The polymer film 12 is relatively thin with a thickness of generally less than about 0.01 inches, preferably about 0.004 inches to 0.015 inches and specifically between about 0.005 inches and 0.01 inches. Also provided is a thermoformable conductive ink 16, such as silver ink. Another material utilized is a hard coat material 20, which in a preferred embodiment of the invention is polysiloxane.

The method also includes providing a robotic printer arm 17 or silk screen 19 that has a template in the shape of a conductive circuit 22. The robotic printer arm 17 is programmed to print the shape of the conductive circuit 22 thereby creating a decorative insert 23. Additionally the method includes providing a mold with a mold cavity 24 that is shaped to receive the decorative insert 23.

As depicted in FIG. 1 the method 10 begins by creating the decorative insert 23 by printing 26 the thermoformable conductive ink 16 onto the polymer film 12 in the shape of the conductive circuit 22. In an optional embodiment of the invention there is a binder layer 18 (shown in FIG. 3) between the conductive ink 16 and the polymer film 12 that assists in binding the conductive ink 16 to the polymer film 12. However, the use of the binder layer 18 is not necessary for all applications. The conductive ink 16 is made of electrically conductive material such as silver. In applications where the silk screen is used, the silk screen is designed to have apertures in the shape of the conductive circuit 22. The silk screen is placed over the polymer film 12 and the thermoformable conductive ink 16 is applied over the silk screen. The thermoformable conductive ink 16 passes through the apertures of the silk screen to deposit the ink on the polymer film 12 in the shape of the conductive circuit 22. It is also within the scope of this invention for the robotic printer arm to be used rather than silk screen.

Next the decorative insert is trimmed to the appropriate size and then a step of placing 28 the decorative insert 23 into the mold cavity 24 occurs. The mold is then closed and a polymer substrate 14 is injected behind the decorative insert 23. The polymer substrate 14 can be any suitable polymer depending on the needs of a particular application. In a preferred embodiment of the invention the polymer substrate 14 is a polycarbonate material that has a suitable transparency level to be use for windshields, sunroofs and light lens covers. During this injection step the decorative insert 23 can flex or bend to form an appropriate shape depending upon the contours of the mold cavity 24 and the pressure exerted by the molten polymer substrate being backfilled onto the decorative insert 15.

Next a step of opening the mold and removing from the mold cavity 24 the polymer substrate with decorative insert attached occurs. Then during a coating step 30 the hard coat material 20 is applied over the side of the decorative insert 23 that has the conductive circuit connected thereon. Alternatively the polymer substrate with decorative insert is dipped into the hard coat material, thereby coating all exposed surfaces. The hard coat material can be applied either by spraying or by dipping. The hard coating material is any material suitable for providing a hard coating layer over the polymer substrate 14 and decorative insert 23. In a preferred embodiment of the invention the hard coat material is a polysiloxane. After the coating step 30 a finished part 31 is completed. The finished part 31 when compared to conventional glass provides about a 40% weight reduction, higher Impact strength and better insulating properties since thermal conductivity of PC is lower than glass. The finished part 31 also has a greater resistance to cracks and shattering, high ductility and high durability. The use of the hard coating process provides long term weathering, and abrasion resistance.

Between the silk screen step 26 and the step of placing 28 the decorative insert into the mold, there can be an optional thermoforming step. However, in a preferred embodiment of the invention the decorative insert has a low thickness (between 0.005 inches and 0.01 inches) of the PC sheet (carriers of the screen printed decoration), and once placed at the mold it will take that shape once they start getting heated; thereby eliminating the need for an additional thermoforming step. With regard to the hard coating step, the whole system is coated with the polysiloxane hard coat preferably the AS4700/SHP470 System (Lexamar's dip coat system or other).

Regarding the conductive circuit 22, it is a defrost grid composed of a flexible circuit composed of silver thermoform able conductive Ink. Lines shall have a uniform thickness, evenly spaced and parallel. The conductive circuit 22 shall be powered by a source of 12.5 V nominal ranging from 9-16 V. Max Current draw 20 A, at average room temperature when 12.5 +−0.1 VDC is applied. The conductive circuit 22 has lines that have a width that is less than or equal to 1 mm, with spacing between the lines being one in the range between 25-30 mm currently used for heater grids on glass windows. The conductive circuit 22 is connected to a terminal connection. The terminal connections to bus are to exceed 100 N. Heated assemblies must not exceed a maximum surface temperature of 65 C in uncovered areas accessible from inside of vehicle and a maximum of 70 C in areas which are not accessible.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of creating a defrost on a polymer substrate comprising the steps of:
providing a polymer film, thermoformable conductive ink, polymer substrate and a hard coat material;
providing a silk screen having a template in the shape of a conductive circuit;
providing a mold with the mold cavity shaped to receive a decorative insert;
silk screening the thermoformable conductive ink onto the polymer film in the shape of a conductive circuit to create a decorative insert;
trimming the decorative insert;
placing the decorative insert into the mold cavity of the mold;
closing the mold and injecting the polymer substrate to the back side of the decorative insert;
opening the mold and removing from the mold cavity the decorative insert with the polymer substrate attached, and
applying the hard coat material over the decorative insert with polymer substrate attached, thereby creating a finished part.

2. The method of claim 1 wherein the thermoformable conductive ink includes silver.

3. The method of claim 1 where in the polymer film and polymer substrate are polycarbonate.

4. The method of claim 1 wherein the polymer film has a thickness between 0.005 inches and 0.01 inches.

5. The method of claim 1 wherein the hard coat material is polysiloxane hard coat.

6. The method of claim 1 further comprising the step of thermoforming the decorative insert prior to placing the decorative insert into the mold cavity.

7. A method of creating a defrost on a polymer substrate comprising the steps of:
providing a polymer film, thermoformable conductive ink, polymer substrate and a hard coat material;
providing a robotic printer arm programmed with a template in the shape of a conductive circuit;
providing a mold with the mold cavity shaped to receive a decorative insert;
printing a conductive circuit onto the polymer film with the robotic printer arm by applying the thermoformable conductive ink in a pattern onto the polymer film to create a decorative insert;
trimming the decorative insert;
placing the decorative insert into the mold cavity of the mold;
closing the mold and injecting the polymer substrate to the back side of the decorative insert;
opening the mold and removing from the mold cavity the decorative insert with the polymer substrate attached, and p1 applying the hard coat material over the decorative insert with polymer substrate attached, thereby creating a finished part.

8. The method of claim 7 wherein the thermoformable conductive ink includes silver.

9. The method of claim 7 where in the polymer film and polymer substrate are polycarbonate.

10. The method of claim 7 wherein the polymer film has a thickness between 0.005 inches and 0.01 inches.

11. The method of claim 7 wherein the hard coat material is polysiloxane hard coat.

12. The method of claim 7 further comprising the step of thermoforming the decorative insert prior to placing the decorative insert into the mold cavity.

13. A finished part with a conductive circuit comprising:
a polymer film layer;
a conductive circuit formed from thermoformable conductive ink formed on the polymer film layer;
a polycarbonate substrate connected to the polymer film layer at a side opposite the conductive circuit;
a hard coat material applied to the polymer film layer and covering the conductive circuit.

14. The finished part of claim 13 further comprising a binder located between the conductive circuit and the polymer film layer.

15. The finished part of claim 13 further comprising the polymer film layer is a polycarbonate film layer.

16. The finished part of claim 15 wherein the polycarbonate film layer has a thickness between 0.005 inches and 0.01 inches.

17. The finished part of claim 13 wherein the polymer film layer has a thickness between 0.005 inches and 0.01 inches.

18. The finished part of claim 13 wherein the hard coat material is polysiloxane hard coat.

19. The finished part of claim 13 wherein the thermoformable conductive ink includes silver.
